(19) United States
(12) Patent Application Publication
(10) Pub. No.: US 2026/0170839 A1
(43) Pub. Date: Jun. 18, 2026

(54) MONITORING APPARATUS, MONITORING METHOD, AND NON-TRANSITORY COMPUTER READABLE MEDIUM

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/421,747

(22) Filed: Dec. 16, 2025

(30) Foreign Application Priority Data
Dec. 18, 2024 (JP) 2024-223601

(51) Int. Cl. G06V 20/52; G06T 7/70; G06V 10/25; G06V 10/26; G06V 10/70; G06V 20/59; G06V 40/10

(52) U.S. Cl. CPC G06V 20/52; G06T 7/70; G06V 10/25; G06V 10/273; G06V 10/70; G06V 20/59; G06V 40/10; G06T 2207/20081; G06T 2207/30196; G06T 2207/30232; G06T 2207/30268; G06V 2201/07

(57) ABSTRACT

A monitoring apparatus includes a controller. The controller inputs an image into a first machine learning model trained on a dataset labeled to indicate whether a monitoring target is present, to determine whether the image contains a monitoring target. When the image contains a monitoring target, the controller generates a prompt containing coordinate information indicating the position of the monitoring target in the image and identification information identifying the monitoring target, and inputs a code of the image and a code of the prompt into a second machine learning model trained on a dataset labeled with states of the monitoring target, to estimate the state of the monitoring target in the image.

### CROSS-REFERENCE TO RELATED APPLICATION

This application claims priority to Japanese Patent Application No. 2024-223601, filed on Dec. 18, 2024, the entire contents of which are incorporated herein by reference.

### TECHNICAL FIELD

The present disclosure relates to a monitoring apparatus, a monitoring method, and a non-transitory computer readable medium.

### BACKGROUND

Monitoring systems for monitoring video for various purposes have been developed. For example, the monitoring system described in Patent Literature (PTL) 1 detects predetermined actions of a person in video, associates and stores, with the person whose predetermined actions have been detected as a detected person, feature information indicating the detected person, the number of detections, information indicating the types of detected predetermined actions, and time information at which the predetermined actions were performed, weights the number of actions within a predetermined time period, sets the detected person as a suspect based on a score, and displays the detected person set as a suspect as identifiable information on a display. This monitoring system further stores the number of detections and identification information identifying the detected person, in association with the feature information indicating the features of the detected person.

In recent years, due to the development of machine learning (deep learning) technology, Large Language Models (LLMs) that understand and process natural language, and Vision-Language Models (VLMs) that understand and process images and natural language have been developed.

### CITATION LIST

### Patent Literature

PTL 1: JP 7168052 B2

### SUMMARY

However, LLMs/VLMs have inferior detection performance compared to recognition-specialized models. When utilizing VLMs in monitoring systems, it is difficult to identify the positions of persons due to estimation from overhead images from cameras installed above and time series, resulting in low recognition performance of the actions of the persons.

It would be helpful to provide a monitoring apparatus, a monitoring method, and a non-transitory computer readable medium capable of estimating the state of a monitoring target with high accuracy.

A monitoring apparatus according to an embodiment of the present disclosure is a monitoring apparatus including a controller configured to:
input an image into a first machine learning model trained on a dataset labeled to indicate whether a monitoring target is present, to determine whether the image contains a monitoring target;
when the image contains a monitoring target, generate a prompt containing coordinate information indicating the position of the monitoring target in the image and identification information identifying the monitoring target; and
input a code of the image and a code of the prompt into a second machine learning model trained on a dataset labeled with states of the monitoring target, to estimate the state of the monitoring target in the image.

A monitoring method according to an embodiment of the present disclosure includes:
inputting, by a monitoring apparatus, an image into a first machine learning model trained on a dataset labeled to indicate whether a monitoring target is present, to determine whether the image contains a monitoring target;
when the image contains a monitoring target, generating, by the monitoring apparatus, a prompt containing coordinate information indicating the position of the monitoring target in the image and identification information identifying the monitoring target; and
inputting, by the monitoring apparatus, a code of the image and a code of the prompt into a second machine learning model trained on a dataset labeled with states of the monitoring target, to estimate the state of the monitoring target in the image.

A non-transitory computer readable medium stores a program configured to cause a computer functioning as a monitoring apparatus to execute operations, the operations including:
inputting an image into a first machine learning model trained on a dataset labeled to indicate whether a monitoring target is present, to determine whether the image contains a monitoring target;
when the image contains a monitoring target, generating a prompt containing coordinate information indicating the position of the monitoring target in the image and identification information identifying the monitoring target; and
inputting a code of the image and a code of the prompt into a second machine learning model trained on a dataset labeled with states of the monitoring target, to estimate the state of the monitoring target in the image.

According to the present disclosure, it is possible to estimate the state of a monitoring target with high accuracy.

### BRIEF DESCRIPTION OF THE DRAWINGS

In the accompanying drawings:

FIG. 1 is a diagram illustrating a schematic configuration of a monitoring system according to an embodiment of the present disclosure;

FIG. 2 is a block diagram illustrating a first functional example of a controller of a monitoring apparatus according to the embodiment of the present disclosure;

FIG. 3 is a diagram illustrating an example of a main image used in the monitoring apparatus according to the embodiment of the present disclosure;

FIG. 4 is a block diagram illustrating a second functional example of the controller of the monitoring apparatus according to the embodiment of the present disclosure;

FIG. 5 is a diagram illustrating an example of a wide viewing angle image used in the monitoring apparatus according to the embodiment of the present disclosure; and

FIG. 6 is a flowchart illustrating an example of operations of the monitoring apparatus according to the embodiment of the present disclosure.

### DETAILED DESCRIPTION

An embodiment of the present disclosure will be described in detail below, with reference to the drawings.

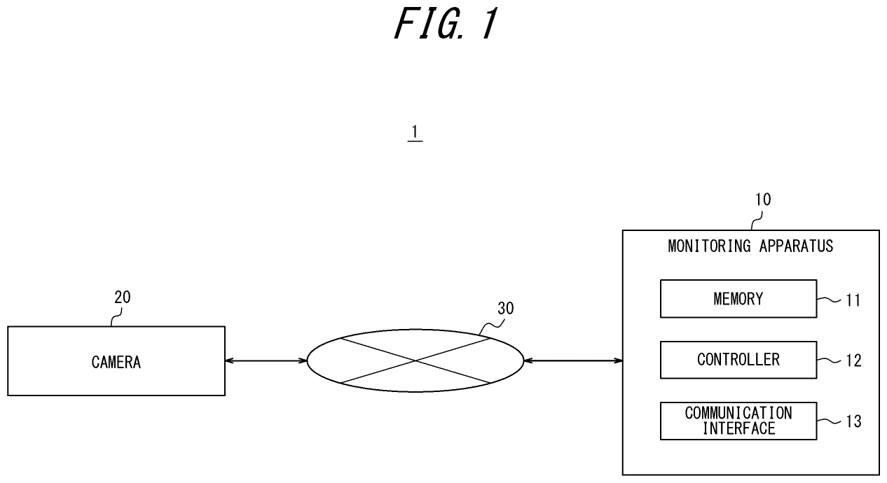

A configuration of a monitoring system according to the embodiment will be described with reference to FIG. 1. A monitoring system 1 illustrated in FIG. 1 includes a monitoring apparatus 10 and a camera 20. The monitoring apparatus 10 and the camera 20 are communicably connected to each other via a network 30 including the Internet.

The camera 20 includes, for example, a charge-coupled device (CCD) camera, a complementary metal-oxide-semiconductor (CMOS) camera, or a high-speed camera. The camera 20 is installed in a vehicle, a house, a building, a store, a street, or the like, and captures images. The camera 20 may be a security camera, a monitoring camera, a pet camera, or the like. The camera 20 may be a webcam. For example, the camera 20 is set on the ceiling of a vehicle such as an automated driving bus or a passenger car, and captures images of the interior of the vehicle from the ceiling. The camera 20 has a communication function and transmits the captured images to the monitoring apparatus 10 via the network 30.

The monitoring apparatus 10 monitors the state of a monitoring target in the images. The state of the monitoring target includes the behavior, action, and posture of the monitoring target, the presence or absence and direction of movement of the monitoring target, the interaction of the monitoring target with an object other than the monitoring target, and the like. The monitoring target may be a living being such as a human or an animal, or may be an inanimate object. The monitoring target may be a plurality of humans, animals, or the like. For example, when the monitoring target is a human, the monitoring apparatus 10 monitors the action of a person captured in the images. The monitoring apparatus 10 includes a memory 11, a controller 12, and a communication interface 13.

The memory 11 includes at least one semiconductor memory, at least one magnetic memory, at least one optical memory, or any combination thereof. The semiconductor memory is, for example, random access memory (RAM), read only memory (ROM), or flash memory. The memory 11 functions as, for example, a main memory, an auxiliary memory, or a cache memory. The memory 11 stores information to be used for operations of the monitoring apparatus 10 and information obtained by operations of the monitoring apparatus 10.

The controller 12 includes at least one processor, at least one programmable circuit, at least one dedicated circuit, or any combination thereof. The processor is a general purpose processor, such as a central processing unit (CPU) or a graphics processing unit (GPU), or a dedicated processor specialized for specific processing. The programmable circuit is, for example, a field-programmable gate array (FPGA). The dedicated circuit is, for example, an application specific integrated circuit (ASIC). The controller 12 executes processes related to operations of the monitoring apparatus 10 while controlling components of the monitoring apparatus 10. These processes by the controller 12 will be described later in detail.

The communication interface 13 includes a communication interface for communicating with the camera 20. The communication interface 13 receives, from the camera 20, the images captured by the camera 20. The communication interface 13 stores the received images in the memory 11.

### First Functional Example

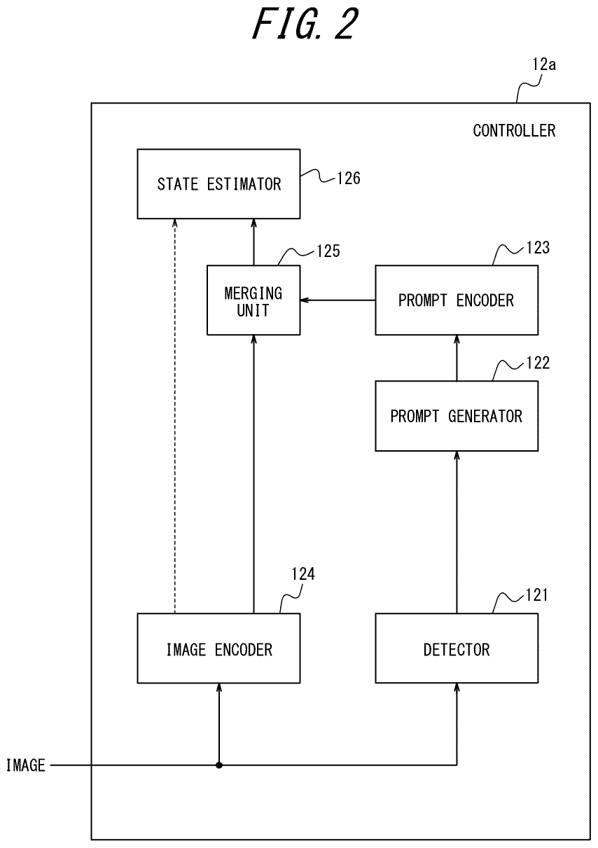

Next, two functional examples of the controller 12 will be described. To distinguish between the two functional examples of the controller 12, the controller 12 is referred to as a controller 12a in a first functional example, and the controller 12 is referred to as a controller 12b in a second functional example. FIG. 2 is a block diagram illustrating a functional example of the controller 12a. The controller 12a illustrated in FIG. 2 includes a detector 121, a prompt generator 122, a prompt encoder 123, an image encoder 124, a merging unit 125, and a state estimator 126.

The detector 121 acquires an image captured by the camera 20 (hereinafter simply referred to as “image”). The detector 121 inputs the image captured by the camera 20 into a first machine learning model, to determine whether the image contains a monitoring target. The first machine learning model is a trained model that has been trained on a dataset labeled to indicate whether a monitoring target is present. The first machine learning model may be stored in the memory 11 or in an external storage of the monitoring apparatus 10. When the image contains a monitoring target, the detector 121 generates coordinate information indicating the position (coordinates) of the monitoring target in the image and outputs the coordinate information to the prompt generator 122.

When the image contains a monitoring target, the prompt generator 122 automatically generates a prompt that contains the coordinate information indicating the position of the monitoring target in the image and identification information identifying the monitoring target. The prompt generator 122 may generate a prompt that contains the size of the image. For example, the prompt generator 122 generates a prompt such as “A person with ID: abc is present at coordinates (x, y) for the image of X×Y pixels. What is the person with ID: abc doing?” In this example, the “size of the image” corresponds to “X×Y pixels”, the coordinate information corresponds to “coordinates (x, y)”, the monitoring target corresponds to “person”, and the “identification information” corresponds to “ID: abc”. Containing the image size in the prompt increases the likelihood that a second machine learning model, which will be described later, accurately recognizes the spatial constraints of the image and performs appropriate processing. In other words, the second machine learning model can utilize the positional information more accurately and improve the accuracy of inference.

The prompt encoder 123 encodes (tokenizes and vectorizes) the prompt generated by the prompt generator 122 using any known encoding method, to generate an encoded prompt.

The image encoder 124 acquires the image captured by the camera 20, and encodes (vectorizes) the image using any known encoding method to generate an encoded image.

The merging unit 125 associates and merges the encoded image generated by the image encoder 124 and the encoded prompt generated by the prompt encoder 123, in order to input the encoded image and the encoded prompt simultaneously into the state estimator 126.

The state estimator 126 inputs the encoded image and the encoded prompt merged by the merging unit 125 into the second machine learning model, to estimate the state of the monitoring target in the image. The second machine learning model is a trained model that has been trained on a dataset labeled with states of the monitoring target. The second machine learning model may be stored in the memory 11 or in an external storage of the monitoring apparatus 10. The “states of the monitoring target” may include sitting, standing, lying down, reading, walking, running, falling, dancing, fighting, playing, and the like, when the monitoring target is a human. Also, when the monitoring target is a pet, the “states of the monitoring target” may include lying down, walking around, jumping, scratching, eating, barking, and the like. The state estimator 126 outputs the result of state estimation to the outside of the monitoring apparatus 10. For example, when the camera 20 is a surveillance camera installed in an automated driving bus, the state estimator 126 transmits the result of state estimation to the bus company.

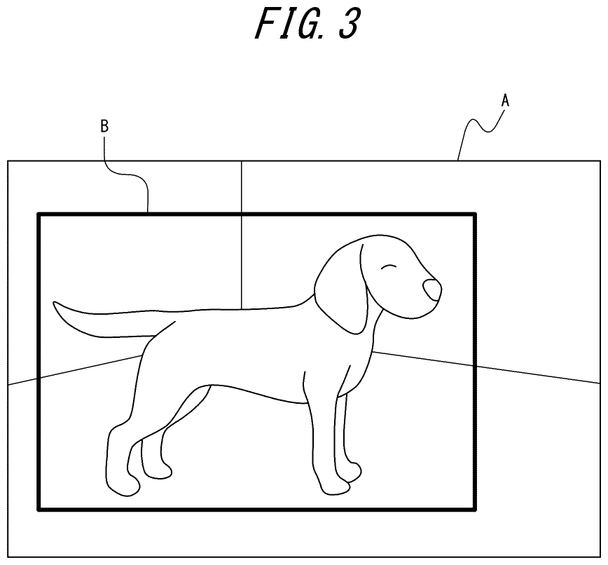

The image encoder 124 may delete, from the image, at least a part of an area at which the monitoring target is not present, and encode the remaining main image. For example, assuming that the image captured by the camera 20 is an image A illustrated in FIG. 3, and the monitoring target is a dog. In this case, the image encoder 124 deletes, from the image A, at least a part of an area at which the dog is not present, and uses a remaining image B as a main image. The image encoder 124 then encodes the main image B, and outputs the encoded main image to the merging unit 125 (as indicated by the solid line in FIG. 2). In general, it is considered that deleting an image of an area at which the monitoring target is not present improves the accuracy of state estimation. On the other hand, when a person has a tool, removing the tool may pose a risk of misestimating the state. Therefore, the image encoder 124 encodes the entire image and outputs the encoded image to the state estimator 126 (as indicated by the broken line in FIG. 2). As a result, the state estimator 126 can estimate the state of the monitoring target while considering an image of a part at which the monitoring target is not present. The image encoder 124 may acquire the coordinate information on the monitoring target from the detector 121. When the detector 121 can detect an object related to the monitoring target, in addition to the monitoring target, the image encoder 124 may extract, from the image, the object related to the monitoring target and the monitoring target, and encode the object related to the monitoring target and the monitoring target.

### Second Functional Example

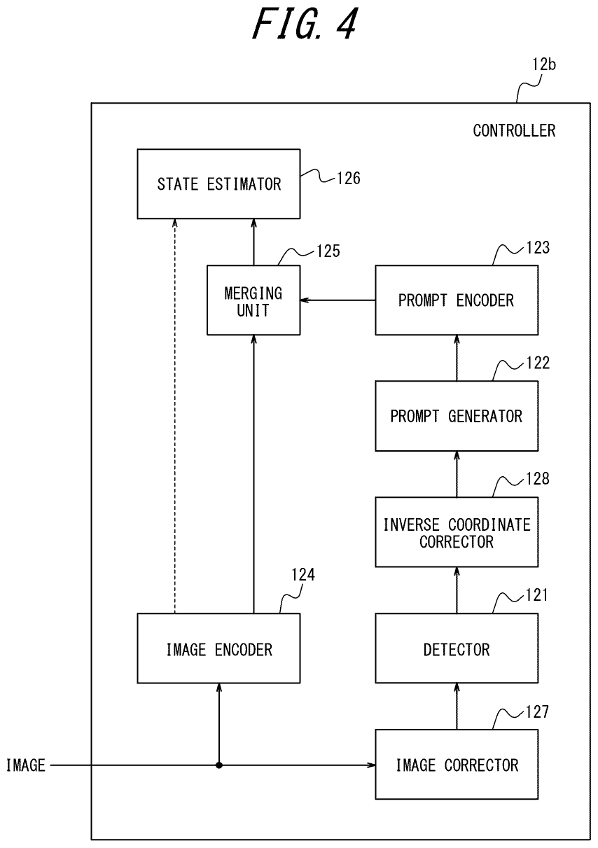

FIG. 4 is a block diagram illustrating a functional example of the controller 12b. The controller 12b illustrated in FIG. 4 includes a detector 121, a prompt generator 122, a prompt encoder 123, an image encoder 124, a merging unit 125, a state estimator 126, an image corrector 127, and an inverse coordinate corrector 128. The difference from the controller 12a is that the controller 12b further includes the image corrector 127 and the inverse coordinate corrector 128. The other configurations are the same as those of the controller 12a, so the same reference numerals are assigned, and an explanation is omitted as appropriate.

The image corrector 127 corrects an image captured by the camera 20 to generate a corrected image. The image corrector 127 may perform any known correction processing such as geometric transformation (affine transformation), noise removal, and edge enhancement. The image corrector 127 outputs the corrected image to the detector 121.

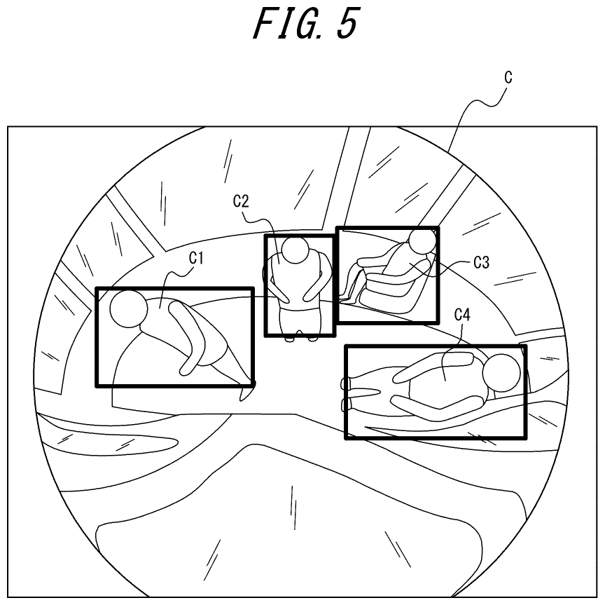

FIG. 5 illustrates an example of a wide viewing angle image C captured by the camera 20 when the camera 20 is equipped with a lens (such as a fisheye lens, ultra-wide-angle lens, or wide-angle lens) with a wide viewing angle (wide angle of view). When distortion occurs as illustrated in the wide viewing angle image C in FIG. 5, the image corrector 127 corrects the distortion.

The detector 121 determines whether the corrected image generated by the image corrector 127 contains a monitoring target. When the corrected image contains a monitoring target, the detector 121 generates first coordinate information indicating the position (first coordinates) of the monitoring target in the corrected image and outputs the first coordinate information to the inverse coordinate corrector 128.

The inverse coordinate corrector 128 performs, on the first coordinates, an inverse correction that reverses the correction made by the image corrector 127. For example, when an affine transformation is performed by the image corrector 127, the inverse coordinate corrector 128 performs an inverse affine transformation. Through this process, the inverse coordinate corrector 128 can obtain second coordinate information indicating the position (second coordinates) of the monitoring target in the image before the correction. The inverse coordinate corrector 128 outputs the second coordinate information to the prompt generator 122.

When the corrected image contains a monitoring target, the prompt generator 122 generates a prompt that contains the second coordinate information indicating the position of the monitoring target in the image before the correction and identification information identifying the monitoring target.

The image encoder 124 performs processing on the image before the correction, as in the controller 12a. The state estimator 126 estimates the state of the monitoring target in the image before the correction, as in the controller 12a. For example, in the example illustrated in FIG. 5, the state estimator 126 estimates the states of monitoring targets C1 to C4, using prompts that include second coordinate information indicating the positions of the respective monitoring targets C1 to C4 in the image C before the correction and identification information identifying the respective monitoring targets C1 to C4.

### Operations of Monitoring Apparatus

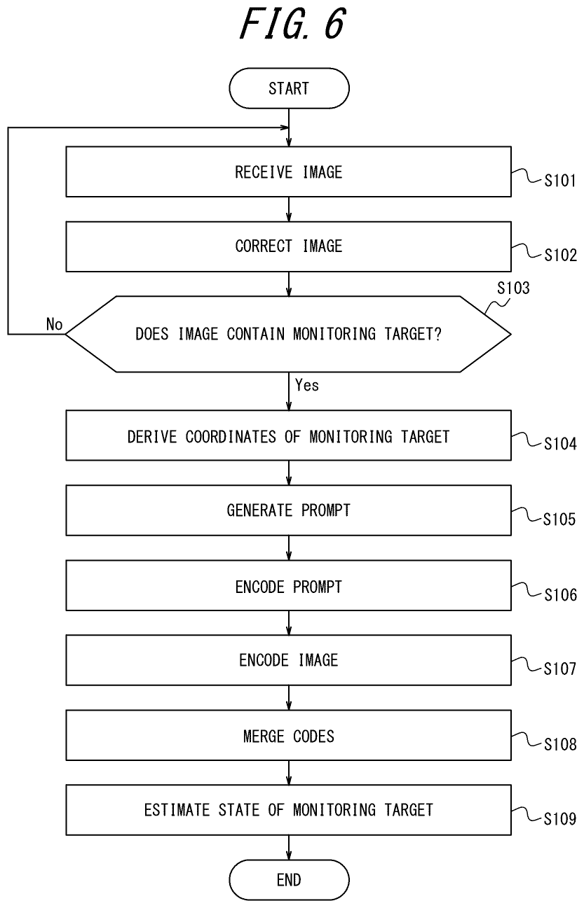

Next, an example of operations of the monitoring apparatus 10 according to the embodiment will be described with reference to FIG. 6. In the example illustrated in FIG. 6, the controller 12 is assumed to have the function illustrated in FIG. 4.

In S101, the communication interface 13 receives an image captured by the camera 20 via the network 30.

In S102, the image corrector 127 corrects the image to generate a corrected image.

In S103, the detector 121 inputs the corrected image into a first machine learning model trained with a dataset labeled to indicate whether a monitoring target is present, to determine whether the corrected image contains a monitoring target. When the corrected image contains a monitoring target, the detector 121 proceeds to S104. When the corrected image does not contain a monitoring target, the monitoring apparatus 10 does not perform subsequent processing and returns to S101.

In S104, the detector 121 generates first coordinate information indicating the position (first coordinates) of the monitoring target in the corrected image. Subsequently, the inverse coordinate corrector 128 performs an inverse correction on the first coordinates, to calculate second coordinate information indicating the position (second coordinates) of the monitoring target in the image before the correction.

In S105, the prompt generator 122 generates a prompt that includes the second coordinate information and identification information identifying the monitoring target.

In S106, the prompt encoder 123 encodes the prompt to generate an encoded prompt.

In S107, the image encoder 124 encodes the image to generate an encoded image. This processing of the image encoder 124 may be performed between S102 and S106, and may be performed in parallel with the processing from S102 to S106.

In S108, the merging unit 125 associates and merges the encoded image and the encoded prompt.

In S109, the state estimator 126 inputs the encoded image and the encoded prompt into a second machine learning model trained on a dataset labeled with states of the monitoring target, to estimate the state of the monitoring target in the image.

As described above, the monitoring apparatus 10 according to the present disclosure determines, using a first machine learning model, whether an image contains a monitoring target. When the image contains a monitoring target, the monitoring apparatus 10 generates a prompt containing coordinate information indicating the position of the monitoring target in the image and identification information identifying the monitoring target, and estimates, using a second machine learning model, the state of the monitoring target in the image based on the image and the prompt. According to the present disclosure, since the detection result of the monitoring target can be reflected in the prompt for the second machine learning model, it is possible to estimate the state of the monitoring target with high accuracy. Since the first machine learning model is specialized for detection and presence determination of a monitoring target, and the second machine learning model is specialized for detailed state estimation, it is possible to divide processing and balance the overall computational load. Furthermore, when the detection result of the first machine learning model is reflected in the prompt, adding the positional information and the identification information on the monitoring target can improve estimation accuracy by the second machine learning model. Additionally, the combined use of the first and second machine learning models makes it possible to skip the state estimation process when the monitoring target is not present, thereby reducing unnecessary computations. Such optimization of processing enables accurate and efficient monitoring even in real-time monitoring systems and resource-constrained environments.

When an image is corrected to generate a corrected image, the monitoring apparatus 10 according to the present disclosure determines, using a first machine learning model, whether the corrected image contains a monitoring target. When the corrected image contains a monitoring target, the monitoring apparatus 10 generates a prompt containing coordinate information indicating the position of the monitoring target in the image before the correction and identification information identifying the monitoring target, and estimates, using a second machine learning model, the state of the monitoring target in the image before the correction, based on the image before the correction and the prompt. According to the present disclosure, correcting the image enables estimation of the state of the monitoring target with high accuracy, even in images that are usually difficult to estimate the state, such as wide viewing angle images. Additionally, performing the state estimation on the image before the correction makes it possible to realize appropriate action estimation based on the situation of the original image.

### Program

It is also possible to cause a computer capable of executing program instructions to function as the monitoring apparatus 10 described above. The program can cause a computer to execute the operations described above, thereby enabling the computer to function as the monitoring apparatus 10.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as a secure digital (SD) card, a digital versatile disc (DVD), or a compact disc read only memory (CD-ROM) on which the program is stored. The program may be distributed by storing the program in a storage of a server and transferring the program from the server to another computer. The program may be provided as a program product.

For example, the computer temporarily stores, in the memory 11, the program stored in the portable medium or the program transferred from the server. Then, the computer reads the program stored in the memory 11 using a processor (controller 12) and executes processes in accordance with the read program using the processor. The computer may read the program directly from the portable medium, and execute processes in accordance with the program. The computer may, each time a program is transferred from the server to the computer, sequentially execute processes in accordance with the received program. Without transferring the program from the server to the computer, processes may be executed by a so-called application service provider (ASP) type service that realizes functions only by execution instructions and result acquisitions. The program encompasses information that is to be used for processing by an electronic computer and is thus equivalent to a program. For example, data that is not a direct command to a computer but has a property that regulates processing of the computer is “equivalent to a program” in this context.

The above-described embodiment has been explained as a representative example, but various modifications or changes can be made without departing from the spirit of the present disclosure. For example, it is possible to combine multiple configuration blocks or processing steps described in the embodiment into one, or to divide one into multiple blocks or steps.

Examples of some embodiments of the present disclosure are described below. However, it should be noted that the embodiments of the present disclosure are not limited to these examples.
[Appendix 1] A monitoring apparatus comprising a controller configured to:
   input an image into a first machine learning model trained on a dataset labeled to indicate whether a monitoring target is present, to determine whether the image contains a monitoring target;
   when the image contains a monitoring target, generate a prompt containing coordinate information indicating a position of the monitoring target in the image and identification information identifying the monitoring target; and
   input a code of the image and a code of the prompt into a second machine learning model trained on a dataset labeled with states of the monitoring target, to estimate a state of the monitoring target in the image.
[Appendix 2] A monitoring apparatus comprising a controller configured to:
   determine using a first machine learning model whether an image contains a monitoring target;
   when the image contains a monitoring target, generate a prompt containing coordinate information indicating a position of the monitoring target in the image and identification information identifying the monitoring target; and
   estimate, using a second machine learning model, a state of the monitoring target in the image based on the image and the prompt.
[Appendix 3] The monitoring apparatus according to appendix 1 or 2, wherein the controller is configured to:
   correct the image to generate a corrected image;
   determine, using the first machine learning model, whether the corrected image contains a monitoring target;
   when the corrected image contains a monitoring target, generate a prompt containing coordinate information indicating a position of the monitoring target in the image before the correction and identification information; and
   estimate, using the second machine learning model, a state of the monitoring target in the image before the correction.
[Appendix 4] The monitoring apparatus according to any one of appendices 1 to 3, wherein the controller is configured to:
   encode the image to generate an encoded image;
   encode the prompt to generate an encoded prompt; and
   estimate, using the second machine learning model, a state of the monitoring target based on the encoded image and the encoded prompt.
[Appendix 5] The monitoring apparatus according to appendix 4, wherein the controller is configured to delete, from the image, a part at which the monitoring target is not present, and encode a remaining image to generate an encoded image.
[Appendix 6] The monitoring apparatus according to any one of appendices 1 to 5, wherein
   the monitoring target is a person, and
   the image is an image that captures an interior of a vehicle from a ceiling of the vehicle.
[Appendix 7] The monitoring apparatus according to any one of appendices 1 to 6, wherein the prompt contains a size of the image.
[Appendix 8] A monitoring method comprising:
   inputting, by a monitoring apparatus, an image into a first machine learning model trained on a dataset labeled to indicate whether a monitoring target is present, to determine whether the image contains a monitoring target;
   when the image contains a monitoring target, generating, by the monitoring apparatus, a prompt containing coordinate information indicating a position of the monitoring target in the image and identification information identifying the monitoring target; and
   inputting, by the monitoring apparatus, a code of the image and a code of the prompt into a second machine learning model trained on a dataset labeled with states of the monitoring target, to estimate a state of the monitoring target in the image.
[Appendix 9] A monitoring method comprising:
   determining, by a monitoring apparatus using a first machine learning model, whether an image contains a monitoring target;
   when the image contains a monitoring target, generating, by the monitoring apparatus, a prompt containing coordinate information indicating a position of the monitoring target in the image and identification information identifying the monitoring target; and
   estimating, by the monitoring apparatus using a second machine learning model, a state of the monitoring target in the image based on the image and the prompt.
[Appendix 10] The monitoring method according to appendix 8 or 9, comprising:
   correcting, by the monitoring apparatus, the image to generate a corrected image;
   determining, by the monitoring apparatus using the first machine learning model, whether the corrected image contains a monitoring target;
   when the corrected image contains a monitoring target, generating, by the monitoring apparatus, a prompt containing coordinate information indicating a position of the monitoring target in the image before the correction and identification information; and
   estimating, by the monitoring apparatus using the second machine learning model, a state of the monitoring target in the image before the correction.
[Appendix 11] The monitoring method according to any one of appendices 8 to 10, comprising:
   encoding, by the monitoring apparatus, the image to generate an encoded image;
   encoding, by the monitoring apparatus, the prompt to generate an encoded prompt; and
   estimating, by the monitoring apparatus using the second machine learning model, a state of the monitoring target in the image based on the encoded image and the encoded prompt.
[Appendix 12] The monitoring method according to appendix 11, comprising deleting, by the monitoring apparatus from the image, a part at which the monitoring target is not present, and encoding a remaining image to generate an encoded image.
[Appendix 13] The monitoring method according to any one of appendices 8 to 12, wherein
   the monitoring target is a person, and
   the image is an image that captures an interior of a vehicle from a ceiling of the vehicle.
[Appendix 14] The monitoring method according to any one of appendices 8 to 13, wherein the prompt contains a size of the image.
[Appendix 15] A program configured to cause a computer functioning as a monitoring apparatus to execute operations, the operations comprising:
   inputting an image into a first machine learning model trained on a dataset labeled to indicate whether a monitoring target is present, to determine whether the image contains a monitoring target;
   when the image contains a monitoring target, generating a prompt containing coordinate information indicating a position of the monitoring target in the image and identification information identifying the monitoring target; and
   inputting a code of the image and a code of the prompt into a second machine learning model trained on a dataset labeled with states of the monitoring target, to estimate a state of the monitoring target in the image.
[Appendix 16] A program configured to cause a computer functioning as a monitoring apparatus to execute operations, the operations comprising:
   determining, using a first machine learning model, whether an image contains a monitoring target;
   when the image contains a monitoring target, generating a prompt containing coordinate information indicating a position of the monitoring target in the image and identification information identifying the monitoring target; and
   estimating, using a second machine learning model, a state of the monitoring target in the image based on the image and the prompt.
[Appendix 17] The program according to appendix 15 or 16, wherein the operations comprise:
   correcting the image to generate a corrected image;
   determining, using the first machine learning model, whether the corrected image contains a monitoring target;
   when the corrected image contains a monitoring target, generating a prompt containing coordinate information indicating a position of the monitoring target in the image before the correction and identification information; and
   estimating, using the second machine learning model, a state of the monitoring target in the image before the correction.
[Appendix 18] The program according to any one of appendices 15 to 17, wherein the operations comprise:
   encoding the image to generate an encoded image;
   encoding the prompt to generate an encoded prompt; and
   estimating, using the second machine learning model, a state of the monitoring target in the image based on the encoded image and the encoded prompt.
[Appendix 19] The program according to appendix 18, wherein the operations comprise deleting, from the image, a part at which the monitoring target is not present, and encoding a remaining image to generate an encoded image.
[Appendix 20] The program according to any one of appendices 15 to 19, wherein
   the monitoring target is a person, and
   the image is an image that captures an interior of a vehicle from a ceiling of the vehicle.

1. A monitoring apparatus comprising a controller configured to:
input an image into a first machine learning model trained on a dataset labeled to indicate whether a monitoring target is present, to determine whether the image contains a monitoring target;
when the image contains a monitoring target, generate a prompt containing coordinate information indicating a position of the monitoring target in the image and identification information identifying the monitoring target; and
input a code of the image and a code of the prompt into a second machine learning model trained on a dataset labeled with states of the monitoring target, to estimate a state of the monitoring target in the image.

2. A monitoring apparatus comprising a controller configured to:
determine using a first machine learning model whether an image contains a monitoring target;
when the image contains a monitoring target, generate a prompt containing coordinate information indicating a position of the monitoring target in the image and identification information identifying the monitoring target; and
estimate, using a second machine learning model, a state of the monitoring target in the image based on the image and the prompt.

3. The monitoring apparatus according to claim 2, wherein the controller is configured to:
correct the image to generate a corrected image;
determine, using the first machine learning model, whether the corrected image contains a monitoring target;
when the corrected image contains a monitoring target, generate a prompt containing coordinate information indicating a position of the monitoring target in the image before the correction and identification information; and
estimate, using the second machine learning model, a state of the monitoring target in the image before the correction.

4. The monitoring apparatus according to claim 2, wherein the controller is configured to:
encode the image to generate an encoded image;
encode the prompt to generate an encoded prompt; and
estimate, using the second machine learning model, a state of the monitoring target based on the encoded image and the encoded prompt.

5. The monitoring apparatus according to claim 4, wherein the controller is configured to delete, from the image, a part at which the monitoring target is not present, and encode a remaining image to generate an encoded image.

6. The monitoring apparatus according to claim 2, wherein
the monitoring target is a person, and
the image is an image that captures an interior of a vehicle from a ceiling of the vehicle.

7. The monitoring apparatus according to claim 2, wherein the prompt contains a size of the image.

8. A monitoring method comprising:
determining, by a monitoring apparatus using a first machine learning model, whether an image contains a monitoring target;
when the image contains a monitoring target, generating, by the monitoring apparatus, a prompt containing coordinate information indicating a position of the monitoring target in the image and identification information identifying the monitoring target; and
estimating, by the monitoring apparatus using a second machine learning model, a state of the monitoring target in the image based on the image and the prompt.

9. The monitoring method according to claim 8, wherein
the determining includes inputting the image into the first machine learning model trained on a dataset labeled to indicate whether a monitoring target is present, to determine whether the image contains a monitoring target, and
the estimating includes inputting a code of the image and a code of the prompt into the second machine learning model trained on a dataset labeled with states of the monitoring target, to estimate a state of the monitoring target in the image.

10. The monitoring method according to claim 8, comprising:
correcting, by the monitoring apparatus, the image to generate a corrected image;
determining, by the monitoring apparatus using the first machine learning model, whether the corrected image contains a monitoring target;
when the corrected image contains a monitoring target, generating, by the monitoring apparatus, a prompt containing coordinate information indicating a position of the monitoring target in the image before the correction and identification information; and
estimating, by the monitoring apparatus using the second machine learning model, a state of the monitoring target in the image before the correction.

11. The monitoring method according to claim 8, comprising:
encoding, by the monitoring apparatus, the image to generate an encoded image;
encoding, by the monitoring apparatus, the prompt to generate an encoded prompt; and
estimating, by the monitoring apparatus using the second machine learning model, a state of the monitoring target in the image based on the encoded image and the encoded prompt.

12. The monitoring method according to claim 11, comprising deleting, by the monitoring apparatus from the image, a part at which the monitoring target is not present, and encoding a remaining image to generate an encoded image.

13. The monitoring method according to claim 8, wherein
the monitoring target is a person, and
the image is an image that captures an interior of a vehicle from a ceiling of the vehicle.

14. The monitoring method according to claim 8, wherein the prompt contains a size of the image.

15. A non-transitory computer readable medium storing a program configured to cause a computer to function as the monitoring apparatus according to claim 1.

16. A non-transitory computer readable medium storing a program configured to cause a computer to function as the monitoring apparatus according to claim 2.

17. A non-transitory computer readable medium storing a program configured to cause a computer to function as the monitoring apparatus according to claim 3.

18. A non-transitory computer readable medium storing a program configured to cause a computer to function as the monitoring apparatus according to claim 4.

19. A non-transitory computer readable medium storing a program configured to cause a computer to function as the monitoring apparatus according to claim 5.

20. A non-transitory computer readable medium storing a program configured to cause a computer to function as the monitoring apparatus according to claim 6.
